(19) United States
(12) Patent Application Publication
(10) Pub. No.: US 2008/0036290 A1
(43) Pub. Date: Feb. 14, 2008

(54) Axle bearing apparatus and method of producing hub shaft for driving wheel bearing apparatus

(75) Inventors: Shigeru Inoue, Yokohama-shi (JP); Takumi Harada, Kawasaki-shi (JP); Yutaka Koma, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: JTEKT CORPORATION, Osaka (JP)

(21) Appl. No.: 11/889,425

(22) Filed: Aug. 13, 2007

(30) Foreign Application Priority Data
Aug. 14, 2006 (JP) P2006-220896

(51) Int. Cl. B60B 37/00; F16C 17/00

(52) U.S. Cl. 301/126; 384/129

(57) ABSTRACT

An axle bearing apparatus includes a hub shaft for common use with a driving wheel bearing apparatus and a driven wheel bearing apparatus, the hub shaft including an axle-mounting flange formed at its outer end portion, and a cylindrical portion formed at an inner side of the flange and having a through hole formed in a center portion of the cylindrical portion, and a bearing portion press-fitted on the cylindrical portion of the hub shaft and including an inner ring, an outer ring and rolling elements disposed between the inner and outer rings. The hub shaft is used for the driven wheel bearing apparatus, and alternatively the through hole in the hub shaft is enlarged in diameter, and a spline are formed axially in an inner surface of the diameter-enlarged through hole, and the hub shaft thus processed is used for the driving wheel bearing apparatus.

### BACKGROUND OF THE INVENTION

This invention relates to an axle bearing apparatus, for example, of an automobile, and more particularly to an axle bearing apparatus for common use with a hub shaft of a driving wheel bearing apparatus and a hub shaft of a driven wheel bearing apparatus, and a method of producing the hub shaft for the driving wheel bearing apparatus.

For example, a hub shaft of a driving wheel bearing apparatus for an automobile and a hub shaft of a driven wheel bearing apparatus have heretofore been provided separately from each other (see, for example, JP-A-2002-206538 and JP-A-2003-54210). Recently, however, in order to reduce costs, there has been developed the type of bearing apparatus for common use with a hub shaft of a driving wheel bearing apparatus and a hub shaft of a driven wheel bearing apparatus.

FIG. 5 is a cross-sectional view of a conventional driven wheel bearing apparatus for common use with a hub shaft of a driving wheel bearing apparatus and a hub shaft of the driven wheel bearing apparatus of an axle bearing apparatus. In the following description, the right side in the drawings will be referred to as “inner side”, while the left side will be referred to as “outer side”.

In FIG. 5, reference character F denotes the driven wheel bearing apparatus, and a flange 2 for mounting a wheel (not shown) thereon is formed on an outer periphery of a hub shaft 1 (made of a steel material) at an outer end portion thereof, the flange 2 having a plurality of bolt insertion holes 3. A cylindrical portion 4 for mounting a bearing portion 10 (described later) thereon is formed on the inner side of the flange 2, and extends in an axial direction. A through hole 5 having an inner diameter d is formed axially through a center portion of the cylindrical portion 4 in concentric relation to this cylindrical portion 4, and larger-diameter portions 6a and 6b are formed respectively at opposite ends of the through hole 5. A cylindrical caulking portion 7 (indicated in broken lines) for fixing the bearing portion 10 is formed at an inner end of the cylindrical portion 4, and projects radially outwardly.

The bearing portion 10 comprises an inner ring 11 divided into two sections each having a rolling contact surface (raceway surface) formed between ribs formed respectively at opposite ends thereof, an outer ring 12 having two rows of rolling contact surfaces, and two rows of tapered rollers (rolling elements) 13 disposed between the inner and outer rings 11 and 12, each row of tapered rollers 13 being disposed between the corresponding rolling contact surfaces of the inner and outer rings 11 and 12. Axial clearances (end play) are formed between each of the inner and outer rings 11 and 12 and the opposite ends of each tapered roller 13.

The bearing portion 10 is press-fitted onto the outer peripheral surface of the cylindrical portion 4 of the hub shaft 1, and then the caulking portion 7 is bent radially outwardly for caulking purposes as indicated in solid lines, and by doing so, the bearing portion 10 is held between a step portion 8 (formed at that portion of the cylindrical portion 4 disposed close to the flange 2) and the caulking portion 7 in such a manner that a preload is applied to this bearing portion 10. Then, the outer ring 12 is mounted on an axle case or other portion (not shown) through a flange 14 formed on the outer periphery of the outer ring 12 in such a manner that the outer ring 12 can not rotate.

FIG. 6 is a cross-sectional view of the driving wheel bearing apparatus D. Although this driving wheel bearing apparatus D is provided with a hub shaft 1 identical in structure to the hub shaft 1 of the driven wheel bearing apparatus F, a female spline portion 9 defined by an axially-extending spline is formed on an inner peripheral surface of a through hole 5, and a spline shaft of a constant velocity joint (not shown) is fitted into this female spline portion 9. This female spline portion 9 is formed on the inner peripheral surface of the through hole 5 formed in the hub shaft 1 identical in structure to the hub shaft 1 of the driven wheel bearing apparatus F, and an inner diameter d of the female spline portion 9 defined by convex portions (ridges) thereof is equal to the inner diameter d of the through hole 5. Incidentally, any literature relating to the structures of FIGS. 5 and 6 has not been found.

In the above axle bearing apparatus for common use with the hub shaft 1 of the driving wheel bearing apparatus D and the hub shaft 1 of the driven wheel bearing apparatus F, the bearing portion 10 is press-fitted on the cylindrical portion 4 of each hub shaft 1. However, the spline shaft of the constant velocity joint is fitted into the female spline portion 9 of the hub shaft 1 of the driving wheel bearing apparatus D, and therefore the bearing portion 10 of the driving wheel bearing apparatus D is tightened by this spline shaft, so that the axial clearances of this bearing portion 10 are reduced to become smaller than the axial clearances of the bearing portion 10 of the driven wheel bearing apparatus F, thus inviting a problem that the axial clearances of the two bearing portions are different from each other.

Therefore, in order to finally make the axial clearances of the two bearing portions equal to each other, there have been prepared two kinds of bearing portions 10 different in axial clearances from each other, and therefore the production and inventory management have been cumbersome, and the costs have been increased.

### SUMMARY OF THE INVENTION

This invention has been made in order to solve the above problems, and an object of the invention is to provide an axle bearing apparatus for common use with a hub shaft of a driving wheel bearing apparatus and a hub shaft of a driven wheel bearing apparatus, in which there is provided a common-use hub shaft which can finally make axial clearances of bearing portions having the same structure press-fitted respectively on the hub shafts of the driving and driven wheel bearing apparatuses generally equal to each other, and a method of producing the hub shaft for the driving wheel bearing apparatus.

According to the present invention, there is provided an axle bearing apparatus comprising:

a hub shaft for common use with a driving wheel bearing apparatus and a driven wheel bearing apparatus, the hub shaft including an axle-mounting flange formed at an outer end portion thereof, and a cylindrical portion formed at an inner side of the flange and having a through hole formed in a center portion of the cylindrical portion; and

a bearing portion press-fitted on the cylindrical portion of the hub shaft and comprising an inner ring, an outer ring and rolling elements disposed between the inner and outer rings,

wherein the hub shaft is used for the driven wheel bearing apparatus, and alternatively the hub shaft in which the through hole is enlarged in diameter and a spline is axially formed in an inner surface of the diameter-enlarged through hole is used for the driving wheel bearing apparatus.

A wall thickness of the cylindrical portion of the hub shaft of the driven wheel bearing apparatus is larger than a wall thickness of the cylindrical portion of the hub shaft of the driving wheel bearing apparatus.

Furthermore, the inner diameter of the through hole in the hub shaft of the driven wheel bearing apparatus is smaller than an inner diameter defined by convex portions of the splines formed at the hub shaft of the driving wheel bearing apparatus.

According to the present invention, there is provided a method of producing a driving wheel bearing apparatus from a hub shaft for a driven wheel bearing apparatus, the method comprising:

providing the hub shaft that includes an axle-mounting flange formed at an outer end portion thereof, and a cylindrical portion formed at an inner side of the flange and having a through hole formed in a center portion of the cylindrical portion;

enlarging the through hole of the hub shaft in diameter;

axially forming a spline in an inner surface of the diameter-enlarged through hole; and

press-fitting a bearing portion on the cylindrical portion of the hub shaft, the bearing portion comprising an inner ring, an outer ring and rolling elements disposed between the inner and outer rings.

In the axle bearing of the present invention, by processing part of the hub shaft (hub shaft material), the hub shaft can be used for both of the driving wheel bearing apparatus and the driven wheel bearing apparatus, and therefore the production and inventory management are easier, and besides the costs can be reduced.

### BRIEF DESCRIPTION OF THE DRAWINGS

FIG. 1 is a cross-sectional view of a hub shaft of a driven wheel bearing apparatus forming a preferred embodiment of an axle bearing apparatus of the present invention.

FIG. 2 is a cross-sectional view taken along the line A-A of FIG. 1.

FIG. 3 is a cross-sectional view of a hub shaft of a driving wheel bearing apparatus forming a preferred embodiment of an axle bearing apparatus of the invention.

FIG. 4 is a cross-sectional view taken along the line B-B of FIG. 3.

### DETAILED DESCRIPTION OF PREFERRED EMBODIMENTS

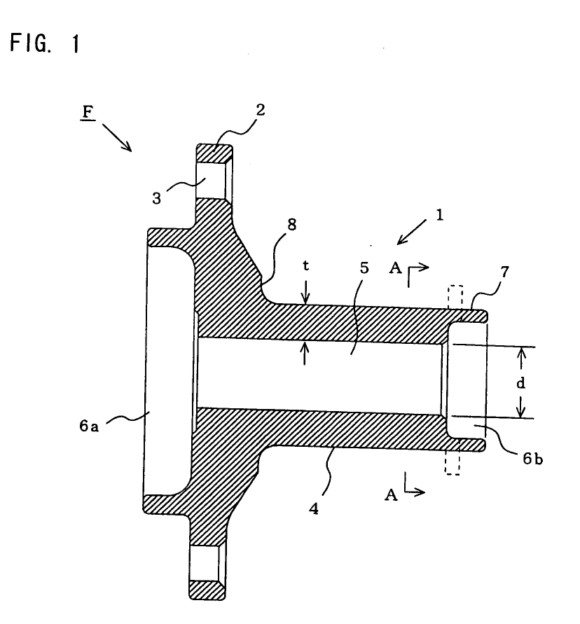

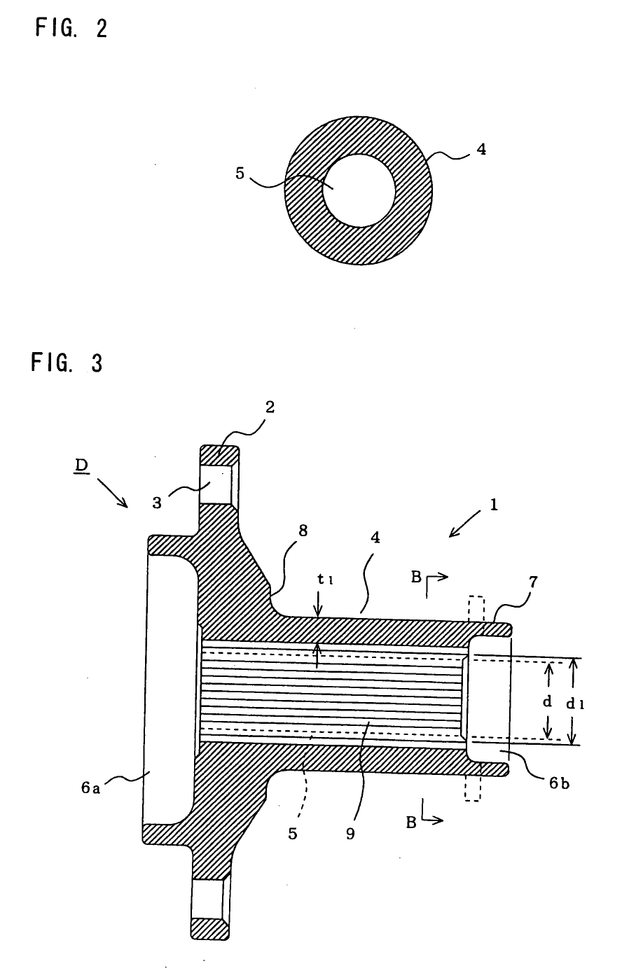

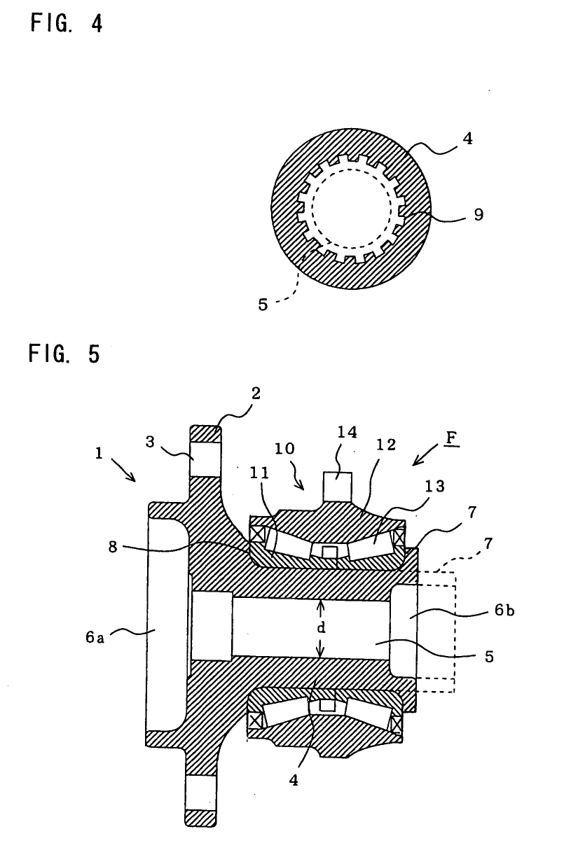

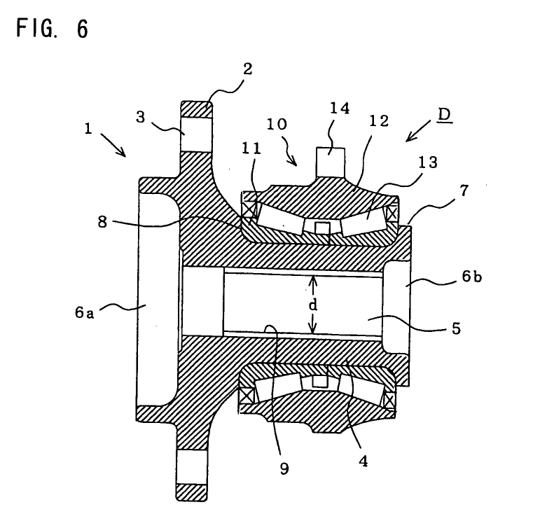

FIG. 1 is a vertical cross-sectional view of a hub shaft which is a main portion of a driven wheel bearing apparatus forming a preferred embodiment of an axle bearing apparatus of the present invention, FIG. 2 is a cross-sectional view taken along the line A-A of FIG. 1, FIG. 3 is a vertical cross-sectional view of a hub shaft which is a main portion of a driving wheel bearing apparatus forming a preferred embodiment of an axle bearing apparatus of the invention, and FIG. 4 is a cross-sectional view taken along the line B-B of FIG. 3. Those portions identical to the corresponding portions of the conventional structures of FIGS. 5 and 6 will be designated by identical reference numerals, respectively, and part of description thereof will be omitted.

A material for each of the hub shafts 1 of the driving and driven wheel bearing apparatuses D and F (the axle bearing apparatus of the invention) is formed into a predetermined shape, for example, by forging, and a through hole 5 having an inner diameter d is formed axially through a center portion of a cylindrical portion 4 in concentric relation thereto. The inner diameter d of this through hole 5 is smaller than an outer diameter of a spline shaft of a constant velocity joint which is to be fitted into a female spline portion 9 formed on an inner surface of the through hole 5 in the hub shaft 1 of the driving wheel bearing apparatus D.

The hub shaft 1 of the driven wheel bearing apparatus F is finally formed by finishing end faces of a flange 2 and an outer peripheral surface of the cylindrical portion 4 of its hub shaft material by machining.

Similarly, with respect to the hub shaft 1 of the driving wheel bearing apparatus D, the cylindrical portion 4, etc., of its hub shaft material are finished by machining, and further the inner diameter of the through hole 5 is enlarged, that is, formed into a larger diameter d₁. This inner diameter d₁ corresponds to an inner diameter defined by grooves in the spline shaft of the above-mentioned constant velocity joint. Then, the female spline portion 9 is axially formed on the inner surface of the diameter-enlarged through hole 5. As a result, a wall thickness t₁ of the cylindrical portion 4 of the hub shaft 1 of the driving wheel bearing apparatus D is smaller than a wall thickness t of the cylindrical portion 4 of the hub shaft 1 of the driven wheel bearing apparatus F (t₁<t).

When a bearing portion 10 is press-fitted on the cylindrical portion 4 of the hub shaft 1 of the driven wheel bearing apparatus F, the bearing portion 10 is tightened since the cylindrical portion 4 has the increased wall thickness t and hence increases rigidity, so that axial clearances of the bearing portion 10 are reduced (become smaller).

On the other hand, when a bearing portion 10 is press-fitted on the cylindrical portion 4 of the driving wheel bearing apparatus D, the amount of change (reduction) of axial clearances of the bearing portion 10 is smaller as compared with the driven wheel bearing apparatus F, since the cylindrical portion 4 has the reduced wall thickness t₁ and hence has low rigidity. However, when the spline shaft of the constant velocity joint is fitted into the female spline portion 9 of the hub shaft 1, the bearing portion 10 is tightened by this spline shaft, so that the axial clearances of the bearing portion 10 are reduced as described above.

In this case, the wall thickness t of the cylindrical portion 4 of the hub shaft 1 of the driven wheel bearing apparatus F is set to a predetermined value obtained by calculation, and by doing so, the amount of reduction of the axial clearances of the bearing portion 10 of the driven wheel bearing apparatus F and the amount of reduction of the axial clearance of the bearing portion 10 of the driving wheel bearing apparatus D can be made generally equal to each other.

Thus, in the invention, the wall thickness t of the cylindrical portion 4 of the hub shaft 1 of the driven wheel bearing apparatus F is larger than the wall thickness t₁ of the cylindrical portion 4 of the hub shaft 1 of the driving wheel bearing apparatus D, thereby the former cylindrical portion 4 has the higher rigidity. Therefore the axial clearances of the two bearing portions 10 press-fitted respectively on the cylindrical portions 4 of the hub shafts 1 of the driven and driving wheel bearing apparatuses F and D can be made generally equal to each other.

In the invention, the hub shaft material having the through hole 5 beforehand formed in the cylindrical portion 4 is prepared, and part of this hub shaft material is finished to provide the hub shaft 1 for the driven wheel bearing apparatus F. With respect to the driving wheel bearing apparatus D, part of the hub shaft material is finished, and then the through hole 5 is enlarged in diameter, and then the female spline portion 9 is formed on the inner surface of the diameter-enlarged through hole 5, thereby providing the hub shaft 1 for the driving wheel bearing apparatus D. Therefore, the common hub shaft (hub shaft material) 1 can be used for the driven and driving wheel bearing apparatuses F and D. Therefore, the production and inventory management are easier, and besides the costs can be reduced. Rolling elements 13 of the bearing portion 10 may be balls.

In the above description, although the present invention is applied to the illustrated axle bearing apparatus, the invention is not limited to it, but can be applied to any other suitable axle bearing apparatus. The rolling elements 13 of the bearing portion 10 may be balls.

What is claimed is:

1. An axle bearing apparatus comprising:
a hub shaft for common use with a driving wheel bearing apparatus and a driven wheel bearing apparatus, the hub shaft including an axle-mounting flange formed at an outer end portion thereof, and a cylindrical portion formed at an inner side of the flange and having a through hole formed in a center portion of the cylindrical portion; and
a bearing portion press-fitted on the cylindrical portion of the hub shaft and comprising an inner ring, an outer ring and rolling elements disposed between the inner and outer rings,
wherein the hub shaft is used for the driven wheel bearing apparatus, and alternatively the hub shaft in which the through hole is enlarged in diameter and a spline is axially formed in an inner surface of the diameter-enlarged through hole is used for the driving wheel bearing apparatus.

2. The axle bearing apparatus according to claim 1, wherein a wall thickness of the cylindrical portion of the hub shaft for the driven wheel bearing apparatus is larger than a wall thickness of the cylindrical portion of the hub shaft for the driving wheel bearing apparatus.

3. The axle bearing apparatus according to claim 1, wherein the inner diameter of the through hole in the hub shaft for the driven wheel bearing apparatus is smaller than an inner diameter defined by convex portions of the spline formed at the hub shaft for the driving wheel bearing apparatus.

4. A method of producing a driving wheel bearing apparatus from a hub shaft for a driven wheel bearing apparatus, the method comprising:
providing the hub shaft that includes an axle-mounting flange formed at an outer end portion thereof, and a cylindrical portion formed at an inner side of the flange and having a through hole formed in a center portion of the cylindrical portion;
enlarging the through hole of the hub shaft in diameter;
axially forming a spline in an inner surface of the diameter-enlarged through hole; and
press-fitting a bearing portion on the cylindrical portion of the hub shaft, the bearing portion comprising an inner ring, an outer ring and rolling elements disposed between the inner and outer rings.
